(19) United States
(12) Patent Application Publication
(10) Pub. No.: US 2020/0041734 A1
(43) Pub. Date: Feb. 6, 2020

(54) OPTICAL MODULE

(71) Applicant: FUJITSU COMPONENT LIMITED, Tokyo (JP)

(72) Inventors: Tatsuhiro Mori, Tokyo (JP); Takeshi Okuyama, Tokyo (JP)

(21) Appl. No.: 16/520,964

(22) Filed: Jul. 24, 2019

(30) Foreign Application Priority Data
Jul. 31, 2018 (JP) 2018-143694

(51) Int. Cl. G02B 6/42

(52) U.S. Cl. CPC G02B 6/4239; G02B 6/4244; G02B 6/4206; G02B 6/4246

(57) ABSTRACT

An optical module includes a board, a lens member, and first, second, and third bonding parts each bonding the board and the lens member. The lens member includes lenses which light from the light emitter enters or light enters the light receiver through. The first bonding part is positioned on a line passing through the center of each of the lenses. The second and third bonding parts are symmetrically positioned with respect to the line.

### CROSS-REFERENCE TO RELATED APPLICATION

The present application is based on and claims priority to Japanese patent application No. 2018-143694, filed on Jul. 31, 2018, the entire contents of which are incorporated herein by reference.

### BACKGROUND OF THE INVENTION

### 1. Field of the Invention

The present invention relates to optical modules.

### 2. Description of the Related Art

Quad small form-factor pluggable (QSFP) optical modules used in the QSFP, which is an interface standard for optical communications, contain an optical module that includes a printed board on which a light emitter and a light receiver are mounted and a lens member with lenses. See Japanese Patent No. 5280742 and International Publication Pamphlet No. WO 2012/086429.

A lens member needs to be bonded such that light emitted from a light emitter enters the lenses of the lens member and light gathered by the lenses enters a light receiver properly. During manufacturing optical modules, however, the light emitter or light receiver may be misaligned with the lenses, and may increase the loss of light entering the lenses from the light emitter or light entering the light receiver from the lenses. Therefore, it is difficult to obtain a desired property, thus resulting in a decrease in the yield.

### SUMMARY

According to an aspect of the present invention, an optical module includes a board, a lens member, and first, second, and third bonding parts each bonding the board and the lens member.

The lens member includes lenses which light from the light emitter enters or light enters the light receiver through. The first bonding part is positioned on a line passing through the center of each of the lenses. The second and third bonding parts are symmetrically positioned with respect to the line.

### BRIEF DESCRIPTION OF THE DRAWINGS

FIGS. 1 and 2 are a plan view and a sectional view, respectively, of an optical module;

FIGS. 3A, 3B, 4A, 4B, 5 and 6 illustrate a process of manufacturing the optical module;

FIG. 7 illustrates the cure shrinkage of an adhesive;

FIGS. 8, 9, 10 and 11 illustrate a process of manufacturing an optical module according to a first embodiment;

FIGS. 12 and 13 are a side view and a sectional view, respectively, of an optical module according to a second embodiment;

FIGS. 14A, 14B, 15A, 15B, 16A and 16B illustrate a process of manufacturing the optical module according to the second embodiment;

FIGS. 17 and 18 illustrate the optical module according to the second embodiment;

FIGS. 19, 20 and 21 illustrate the optical module according to the second embodiment;

FIGS. 22, 23, 24, 25, 26, 27, 28, 29 and illustrate variations of the optical module according to the second embodiment;

FIGS. 31A and 31B illustrate an optical module according to a third embodiment; and

FIGS. 32 and 33 illustrate variations of the optical module according to the third embodiment.

### DESCRIPTION OF THE EMBODIMENTS

Embodiments of the present invention are described below with reference to the accompanying drawings. The same members or the like are referred to using the same reference numeral, and duplicate description thereof is omitted. In the following, the embodiments are described using an XYZ coordinate system as defined in the drawings.

### First Embodiment

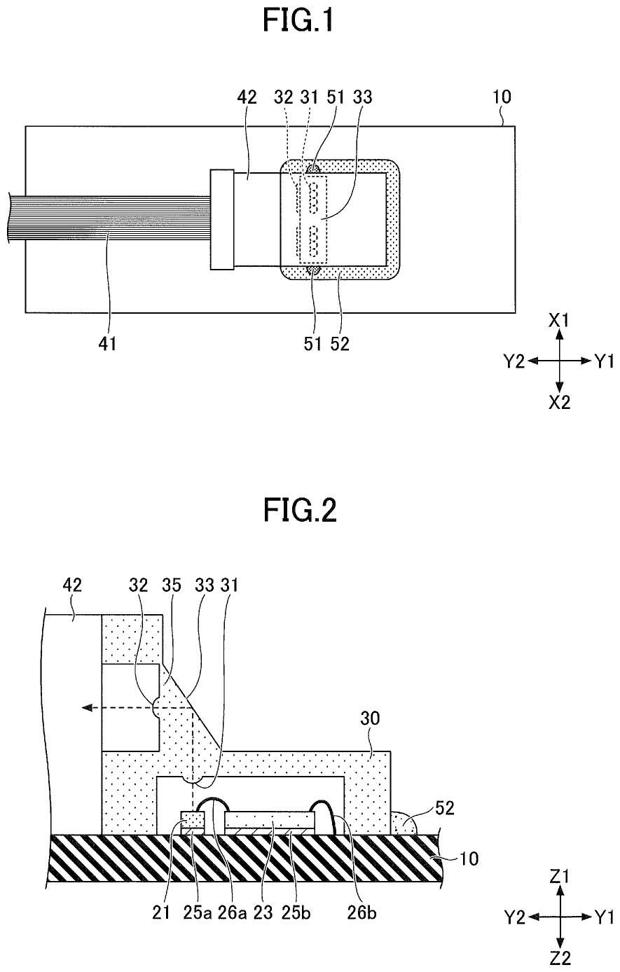

An optical module including a light emitter, a light receiver and a lens member is described with reference to FIGS. 1 and 2, which are a plan view and a sectional view of the optical module. The optical module includes a printed board 10 onto which a light emitter 21 such as a vertical cavity surface emitting laser (VCSEL), a light receiver 22 such as a photodiode, a driver 23, and a transimpedance amplifier (TIA) 24 are joined with silver paste 25a or 25b. The light emitter 21 is connected to the driver 23, the light receiver 22 is connected to the TIA 24, and the driver 23 and the TIA 24 are connected to the printed board 10 by bonding wires 26a or 26b. The printed board 10 includes a substrate formed of a polyimide or the like on which interconnects and electrode terminals are formed, for example.

A lens member 30 is bonded to the printed board 10 with adhesives 51 and 52 in such a manner as to cover the light emitter 21, the light receiver 22, the driver 23, and the TIA 24. The Z2 surface of the lens member 30 is substantially rectangular, and the Z1 surface of the lens member 30 protrudes to form a light transmitting part 35. In a region of the lens member 30 where the transmitting part 35 is formed, a lens array of first lenses 31 is formed in a Z2 surface, and a lens array of second lenses 32 is formed in a Y2 surface. The transmitting part 35 includes a mirror 33 which is a flat slope formed at an angle of 45° to the XY plane. In the other drawings, a part of the lens member or the lens member of a different structure from the lens member of FIG. 2 may be depicted.

The lens member 30 is formed of a light-transmitting resin. Light enters or exits the second lenses 32 from the Y2 side, and a mechanically transferable (MT) ferrule 42 to which optical fibers 41 are connected is connected to the Y2 surface of the lens member 30.

Light emitted from the light emitter 21 enters the corresponding first lenses 31 and propagates through the transmitting part 35 to be reflected at the mirror 33. The reflected light is deflected in the Y2 direction and propagates through the transmitting part 35 to be gathered by the corresponding second lenses 32. The light enters the optical fibers 41 through the MT ferrule 42 and propagates through the optical fibers 41.

Although not depicted, light propagating through the optical fibers 41 enters the second lenses 32 through the MT ferrule 42, and propagates through the transmitting part 35 to be reflected at the mirror 33. The reflected light is deflected in the Z2 direction and propagates through the transmitting part 35 to be gathered by the first lenses 31. The gathered light enters the light receiver 22 and is detected as an optical signal.

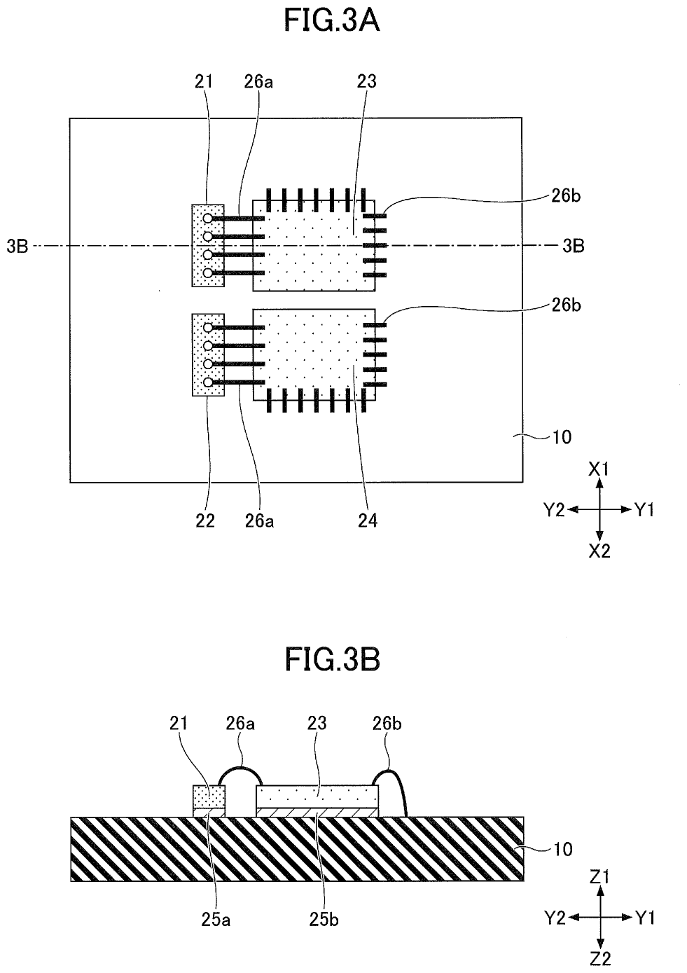

A manufacturing process of the optical module is described with reference to FIGS. 3A through 6.

As depicted in FIGS. 3A and 3B, the light emitter 21, the light receiver 22, the driver 23, and the TIA 24 are attached on the printed board 10. FIG. 3B is a sectional view taken along the line 3B-3B in FIG. 3A. The light emitter 21 and the light receiver 22 are joined to the printed board 10 by the silver paste 25a. The driver 23 and the TIA 24 are joined to the printed board 10 by the silver paste 25b. Thereafter, the light emitter 21 and the driver 23 are connected and the light receiver 22 and the TIA 24 are connected by the bonding wires 26a. The driver 23 and the TIA 24 are connected to the printed board 10 by the bonding wires 26b.

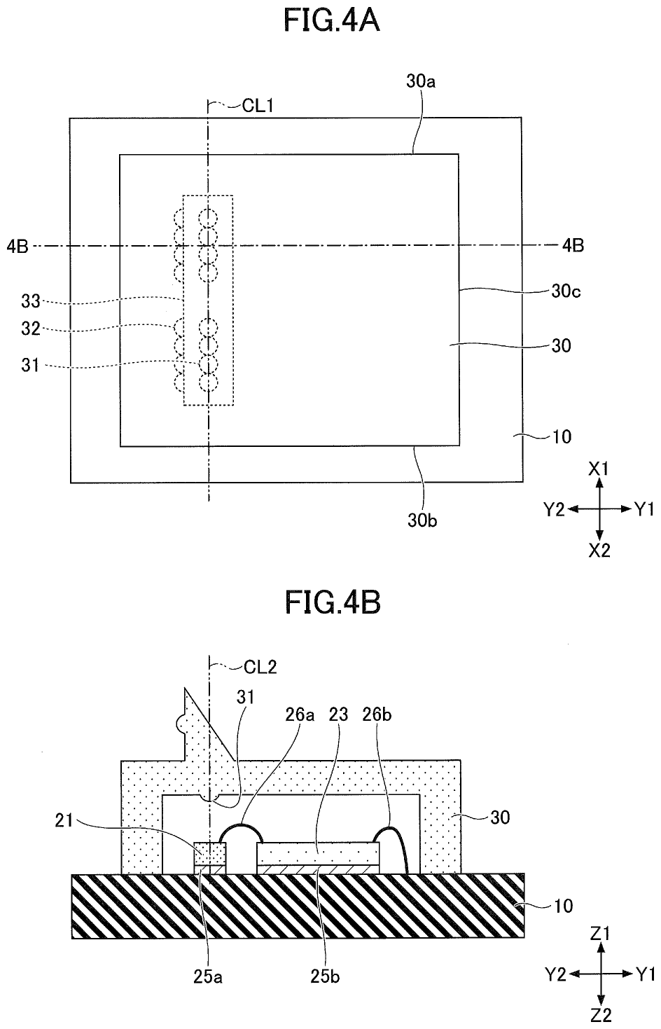

Next, as illustrated in FIGS. 4A and 4B, the lens member 30 is placed on the printed board 10, such that a light emission center of each light emitter 21 and a light reception center of each light receiver 22 is aligned with the corresponding first lens 31. FIG. 4B is a sectional view taken along the line 4B-4B in FIG. 4A. A line CL1 passes through the centers of the first lenses 31, and a line CL2 represents the optical axis of each first lens 31.

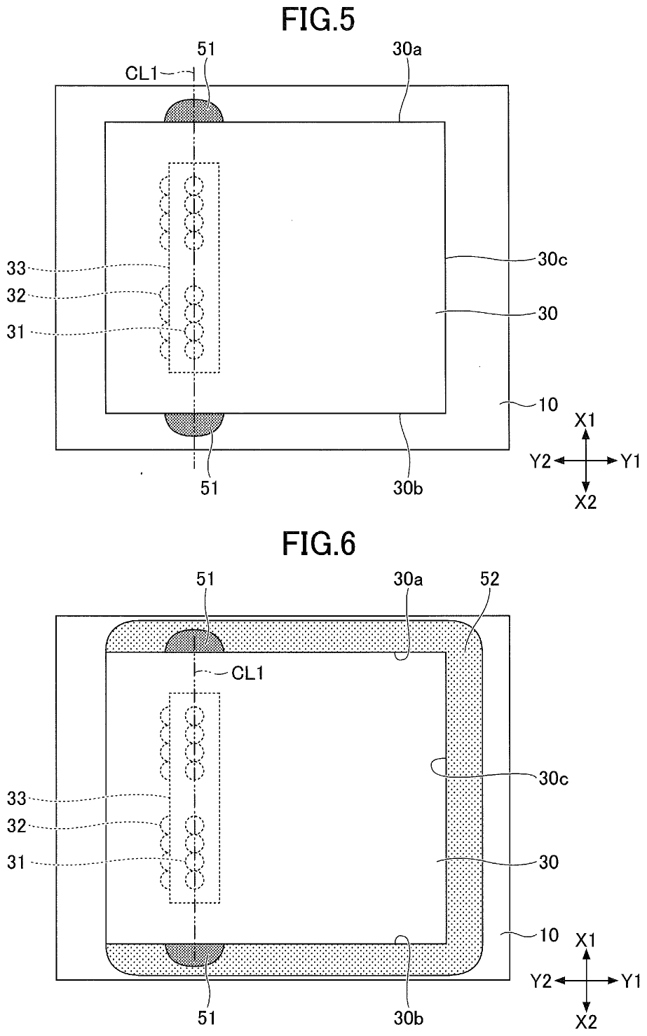

Next, as illustrated in FIG. 5, the lens member 30 is provisionally bonded to the printed board 10 by an adhesive 51 such as an ultraviolet (UV) curable resin. The adhesive 51 is applied on a side surface 30a and a side surface 30b of the lens member 30 on the line CL1.

Next, as illustrated in FIG. 6, the lens member 30 is permanently bonded to the printed board 10 by an adhesive 52 such as an epoxy adhesive. The adhesive 52 is applied on the side surface 30a, the side surface 30b, and a side surface 30c of the lens member 30.

The lens member 30 is bonded to the printed board 10 in two stages. As a result, misalignment between the centers of the first lenses 31 and the light emission centers and the light reception centers is controlled.

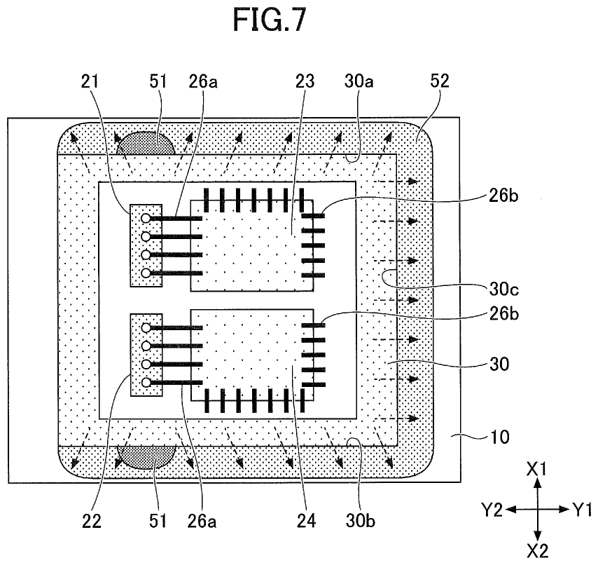

An epoxy adhesive used for the adhesive 52 shrinks when cured. As illustrated in FIG. 6, the adhesive 52 applied along the periphery of the lens member 30 is larger in amount on the Y1 side than on the Y2 side with reference to the line CL1. The shrinking adhesive 52 pulls the lens member 30 in dashed arrows directions as illustrated in FIG. 7, and the lens member 30 is pulled toward the Y1 side on which the applied adhesive 52 is larger in amount. Meanwhile, the amount of the adhesive 51 for the provisional bonding is small, and the area of application is narrow. Therefore, the adhesive 51 cannot resist a force the shrinking adhesive 52 generates, so that the lens member 30 moves in the Y1 direction relative to the printed board 10. As a result, the centers of the first lenses 31 are misaligned with the light emission centers and the light reception centers, so that the optical loss between the first lenses 31 and the light emitter 21 and the light receiver 22 increases.

When the MT ferrule 42 is connected to the optical module, the lens member 30 may receive a force acting in the Y1 direction. Further, the optical fibers 41 connected to the MT ferrule 42 are bent in a sagging manner when installed. Therefore, a force is continuously applied in a direction in which the optical fibers 41 stretch, namely, the Y1 direction. These forces may cause misalignment between the first lenses 31 and the light emission centers and the light reception centers, and the optical loss between the first lenses 31 and the light emitter 21 and the light receiver 22 increases.

A method of manufacturing an optical module according to a first embodiment is described.

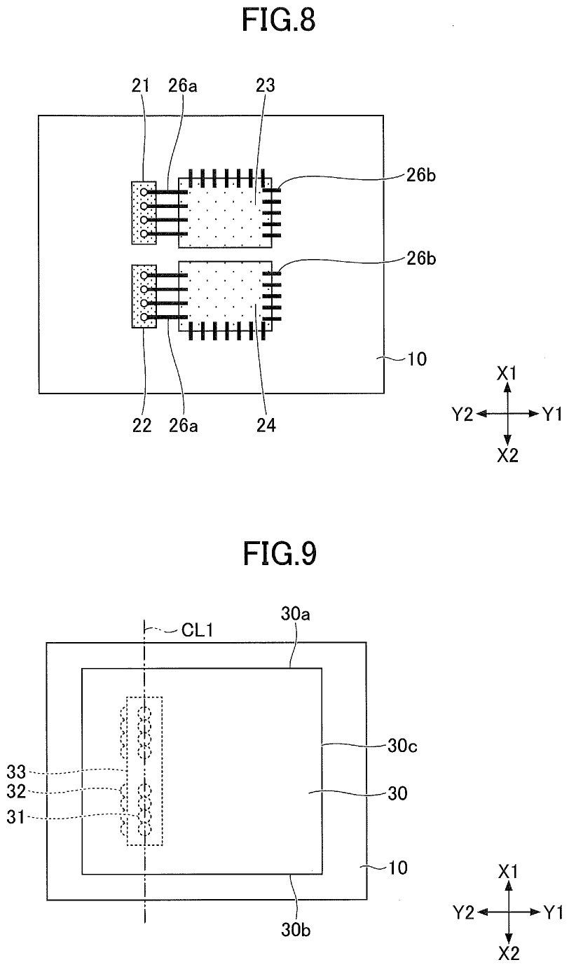

First, as illustrated in FIG. 8, the light emitter 21, the light receiver 22, the driver 23, and the TIA are attached on the printed board 10. Next, as illustrated in FIG. 9, the lens member 30 is aligned with and placed on the printed board 10.

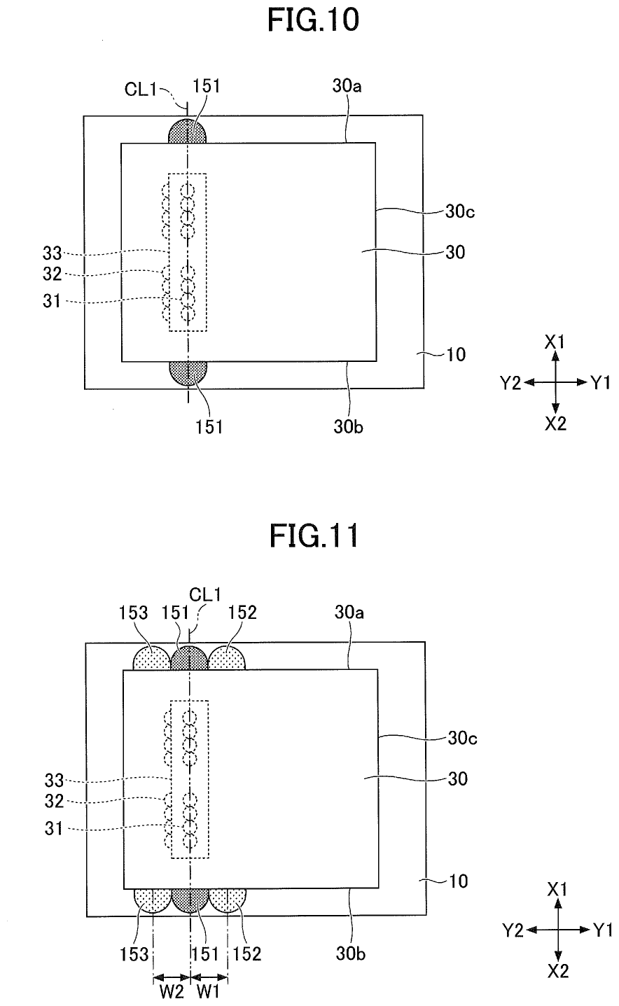

Next, as illustrated in FIG. 10, the lens member 30 is provisionally bonded to the printed board 10 by a first bonding part 151. An adhesive such as a UV curable resin may be applied on the side surface 30a and the side surface 30b on the line CL1, and is exposed to UV radiation to be cured.

Next, as illustrated in FIG. 11, the lens member 30 is permanently bonded to the printed board 10 by a second bonding part 152 and a third bonding part 153. An adhesive such as an epoxy adhesive may be applied on each side of the first bonding part 151 on the side surface 30a and the side surface 30b.

In FIG. 11, the adhesive is applied such that a distance W1 between the centers of the first bonding part 151 and the second bonding part 152 is equal to a distance W2 between the centers of the first bonding part 151 and the third bonding part 153. The second bonding part 152 and the third bonding part 153 are symmetrical with respect to the line CL1. The second bonding part 152 and the third bonding part 153 are equal in amount.

By applying adhesives at positions equidistant from the first bonding part 151, a force generated in a direction to pull the lens member 30 in the Y1 direction when the second bonding part 152 shrinks and a force generated in a direction to pull the lens member 30 in the Y2 direction when the third bonding part 153 shrinks are substantially equal. Therefore, the lens member 30 does not move relative to the printed board 10 to be fixed to a position at which the lens member 30 is provisionally bonded. Accordingly, there is no misalignment between the first lenses 31 and the light emission centers and the light reception centers, and it is possible to prevent an increase in the optical loss between the first lenses 31 and the light emitter 21 and the light receiver 22.

While the mirror 33 is provided according to the embodiment, the first lenses 31 and the second lenses 32 may alternatively be connected by optical waveguides.

### Second Embodiment

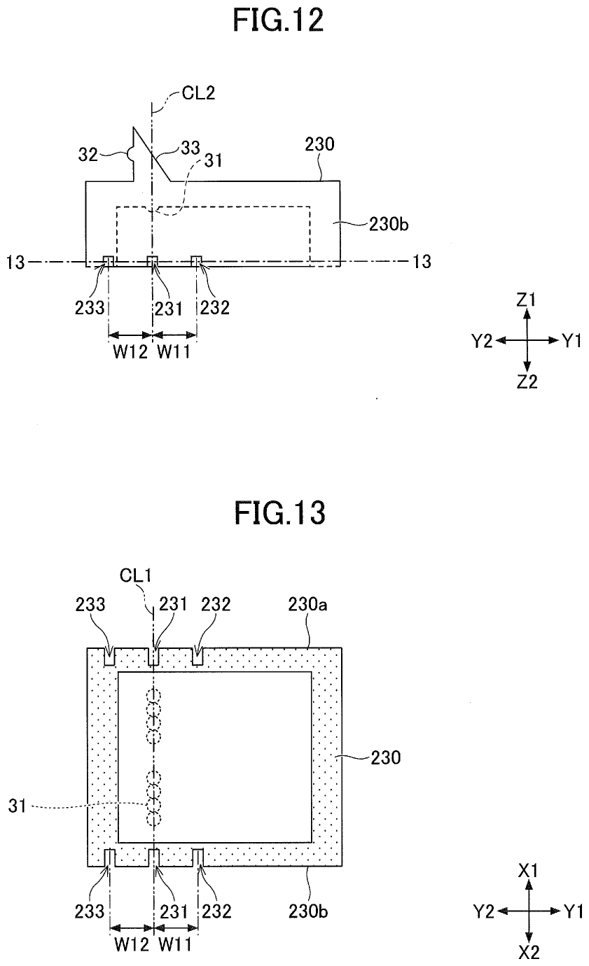

An optical module according to a second embodiment is described. FIG. 12 is a side view of a lens member 230. FIG. 13 is a sectional view of the lens member 230 taken along the line 13-13 in FIG. 12. FIG. 13 indicates positions of the first lenses 31 by the dashed line. Referring to FIGS. 12 and 13, first recesses 231 are formed one in each of a side surface 230a and a side surface 230b of the lens member 230 on the line CL1. A second recess 232 and a third recess 233 are formed on the Y1 side and the Y2 side of each first recess 231 at positions equidistant from the first recess 231.

The rectangular first, second, and third recesses 231, 232, and 233 are provided in the Z2 surface of the lens member 230 that connects to the printed board 10. An interval W11 between the center of the first recess 231 and the center of the second recess 232 is equal to an interval W12 between the center of the first recess 231 and the center of the third recess 233. The second recesses 232 and the third recesses 233 are symmetrically positioned with respect to the line CL1.

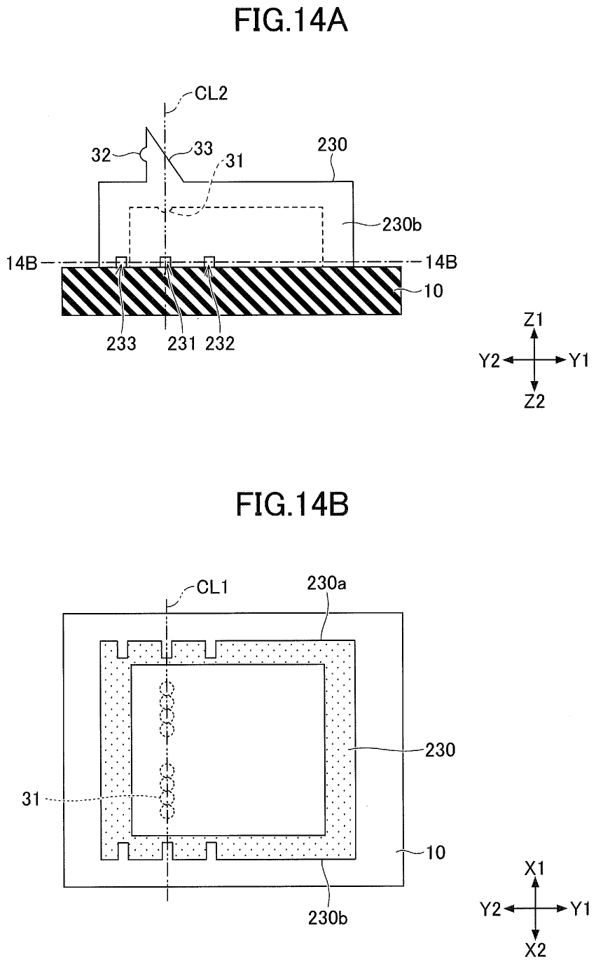

A method of manufacturing an optical module according to the embodiment is described with reference to FIGS. 14A through 16B. The illustration of the light emitter 21, the light receiver 22, the driver 23 and the TIA 24 is omitted. In FIGS. 14B, 15B and 16B, the positions of the first lenses 31 are indicated by the dashed line.

First, as illustrated in FIGS. 14A and 14B, the lens member 230 is aligned with and placed on the printed board 10. FIG. 14B is a sectional view taken along the line 14B-14B in FIG. 14A.

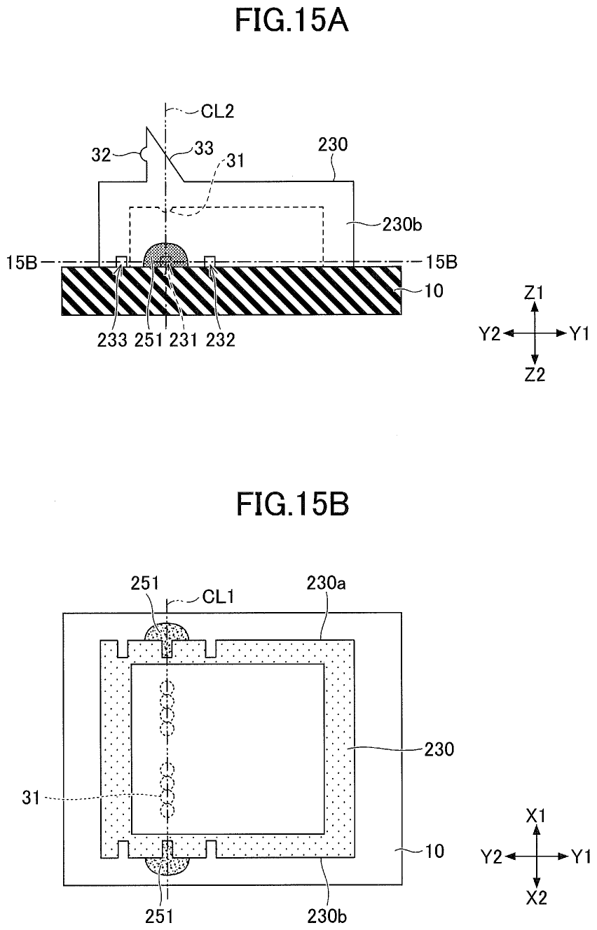

Next, as illustrated in FIGS. 15A and 15B, the lens member 230 is provisionally bonded to the printed board 10 by a first bonding part 251. FIG. 15B is a sectional view taken along the line 15B-15B in FIG. 15A. A UV curable resin is applied to the first recesses 231, and is exposed to UV radiation to be cured.

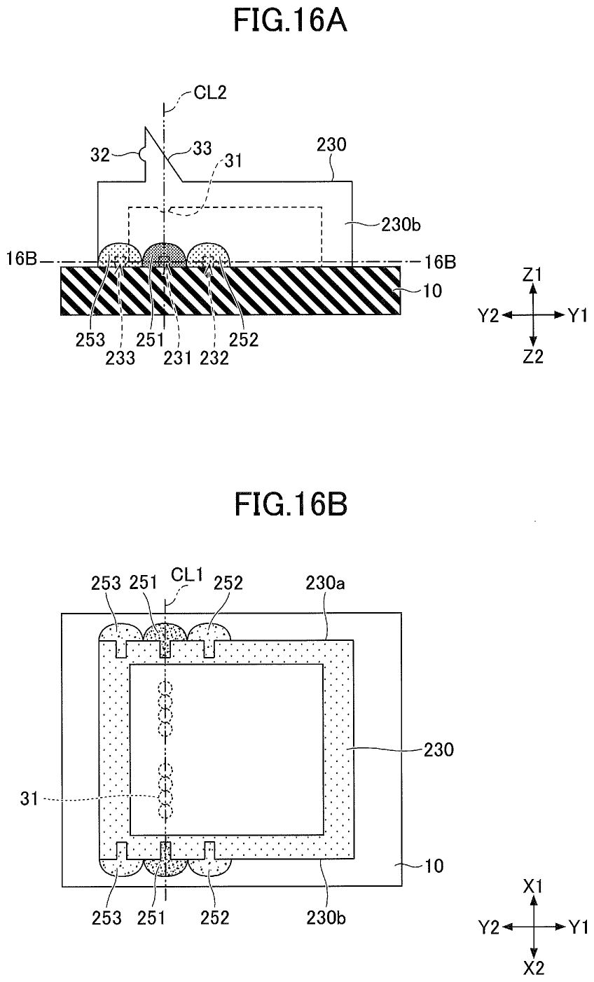

Next, as illustrated in FIGS. 16A and 16B, the lens member 230 is permanently bonded to the printed board 10 by a second bonding part 252 and a third bonding part 253. An epoxy adhesive is applied to the lens member 230 at positions where the second recesses 232 and the third recesses 233 are formed. The amounts of the adhesive applied to the second recesses 232 and to the third recesses 233 are equal.

On condition that the first recesses 231 are provided, the second and the third bonding part may be provided without providing the second recesses 232 and the third recesses 233. Conversely, on condition that the second recesses 232 and the third recesses 233 are provided, the first bonding part may be provided without providing the first recesses 231.

The second bonding part 252 and the third bonding part 253 are symmetrically positioned with respect to the line CL1. The distance from the second bonding part 252 to the first bonding part 251 is equal to the distance from the third bonding part 253 to the first bonding part 251. Accordingly, a force during the cure shrinkage of the second bonding part 252 is substantially equal to a force during the cure shrinkage of the third bonding part 253, so that the lens member 230 is pulled by equal forces. Therefore, the lens member 230 does not move relative to the printed board 10, and the lens member 230 can be fixed at a desired position.

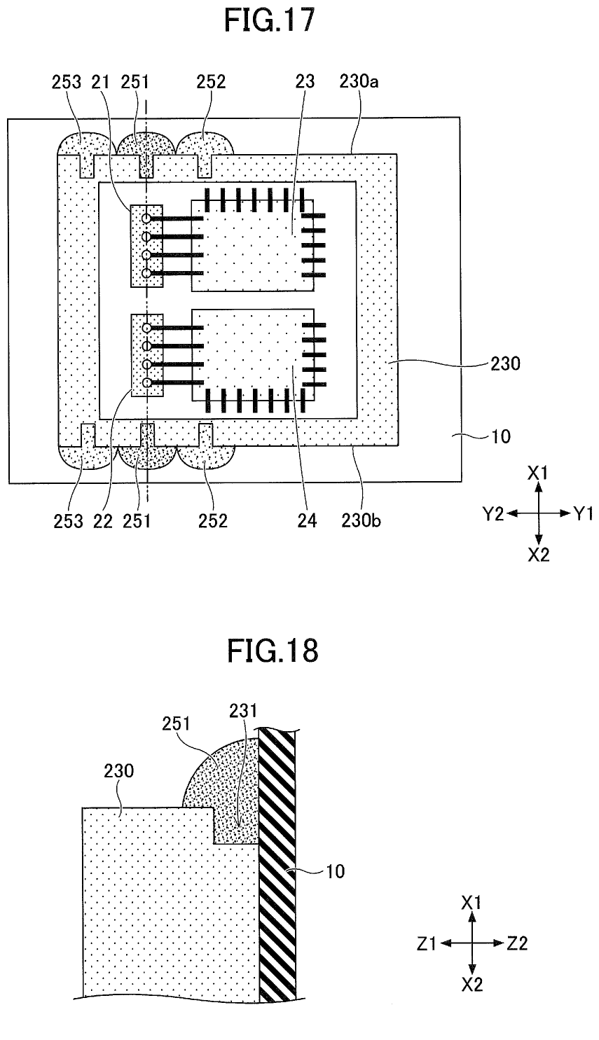

Accordingly, there is no misalignment between the centers of the first lenses 31 and the light emission centers and the light reception centers. As a result, it is possible to prevent an increase in the optical loss between the first lenses 31 and the light emitter 21 and the light receiver 22. FIG. 17 illustrates the positional relationship of the light emitter 21, the light receiver 22, the driver 23, the TIA 24 and the first lenses 31 of the optical module.

When the lens member 230 is bonded to the printed board 10 with the adhesives applied to the recesses 231 through 233 as illustrated in FIG. 18, the bonding area is increased compared with the case where no recesses are provided. Therefore, the bonding strength of the printed board 10 and the lens member 230 is improved.

A force due to the cure shrinkage of the second bonding part 252 and the third bonding part 253 acts on the lens member 230 during their formation. The first bonding part 251, however, extends deep into the first recesses 231. Therefore, the anchoring effect due to the first bonding part 251 further prevents the lens member 230 from moving.

The bonding area also increases in the second bonding part 252 at the second recesses 232 and the third bonding part 253 at the third recesses 233. Therefore, the bonding strength of the printed board 10 and the lens member 230 is improved, and after the adhesives cure, the anchoring effect can prevent the lens member 230 from moving even when the lens member 230 receives an external force.

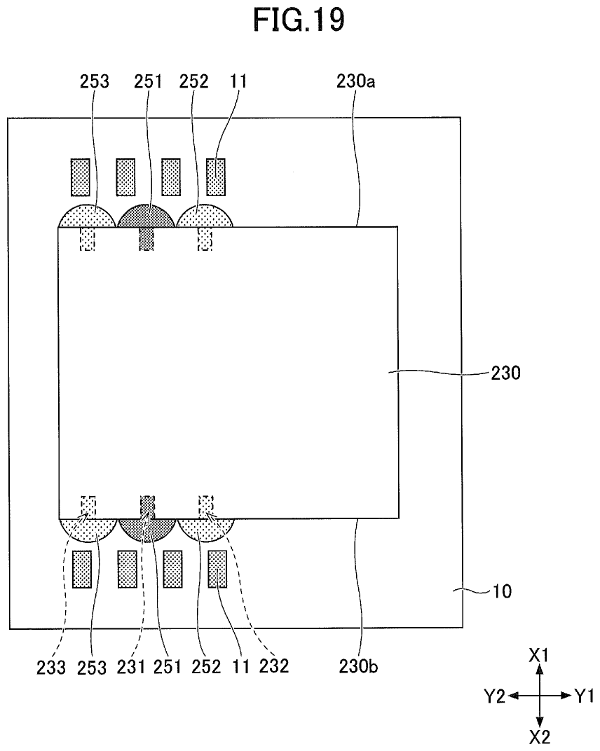

When electronic components 11 are provided near the lens member 230 on the printed board 10 as illustrated in FIG. 19, the bonding area may vary if the applied adhesive spreads to the components 11, and accordingly the bonding strength may vary.

However, the applied adhesive enters the first recesses 231 to be prevented from spreading to the vicinity of the components 11. The same is the case with the second bonding part 252 at the second recesses 232 and the third bonding part 253 at the third recesses 233.

The first bonding part 251, the second bonding part 252 and the third bonding part 253 may be formed of the same adhesive. However, it is preferable that the first bonding part 251 be formed of a UV curable resin and the second bonding part 252 and the third bonding part 253 be formed of a thermosetting resin in view of strength.

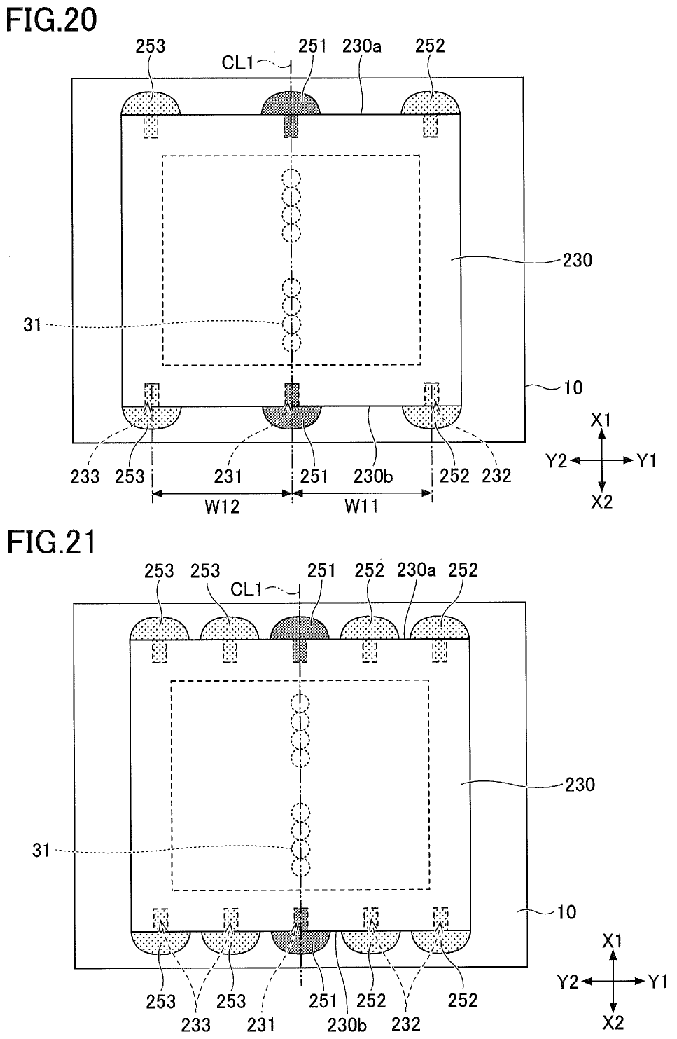

While being approximately 2 mm in FIG. 13, the intervals W11 and W12 may be wider as illustrated in FIG. 20, 5 mm to 6 mm for instance.

As illustrated in FIG. 21, two or more second and third recesses 232 and 233 of equal number may be symmetrically provided with respect to the line CL1. Accordingly, the second bonding parts 252 and the third bonding parts 253 of equal number are symmetrically positioned.

### Variations

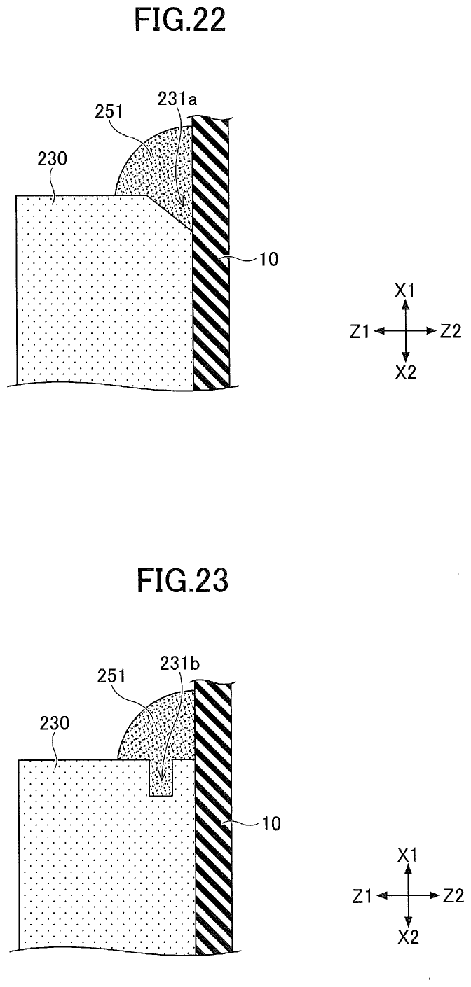

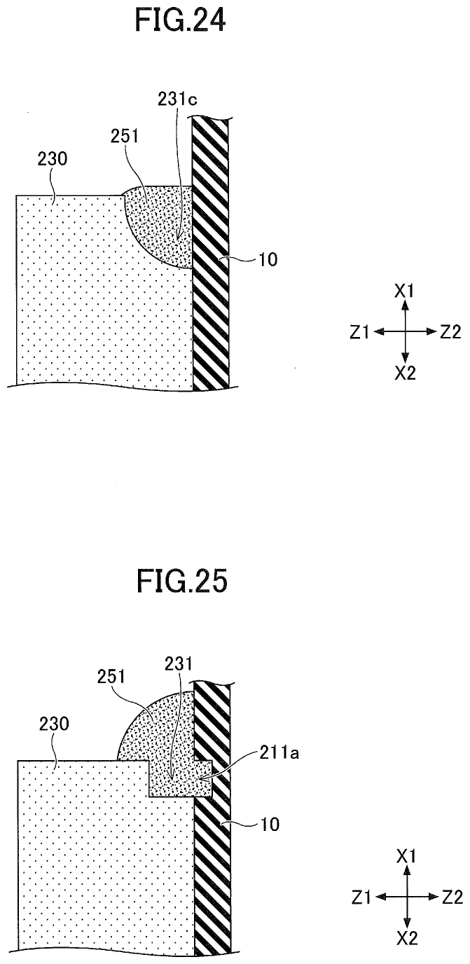

As illustrated in FIG. 22, first recesses 231a may be so formed as to narrow toward the inside of the lens member 230. As illustrated in FIG. 23, first recesses 231b may be provided near the Z2 end of the lens member 230. As illustrated in FIG. 24, first recesses 231c may be formed with a curved surface. The shapes of the first recesses 231a through 231c are also applicable to the second recesses 232 and the third recesses 233.

As illustrated in FIG. 25, recesses 211a may be formed in the printed board 10 at positions corresponding to the first recesses 231, and the first bonding part 251 may be formed by applying an adhesive to the first recesses 231 and the recesses 211a. Because the adhesive also enters the recesses 211a, the bonding area increases to improve the strength of the bonding of the printed board 10 and the lens member 230 by the first bonding part 251.

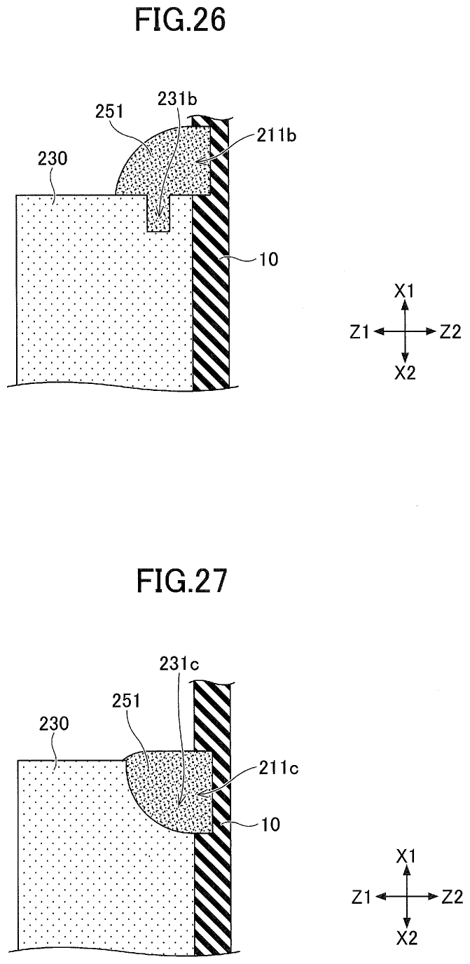

Likewise, as illustrated in FIG. 26, recesses 211b may be formed in the printed board 10 outside the lens member 230. An adhesive is applied to the first recesses 231b and the recesses 211b. As illustrated in FIG. 27, recesses 211c may be formed in the printed board 10 at positions corresponding to the first recesses 231c. An adhesive is applied to the first recesses 231c and the recesses 211c.

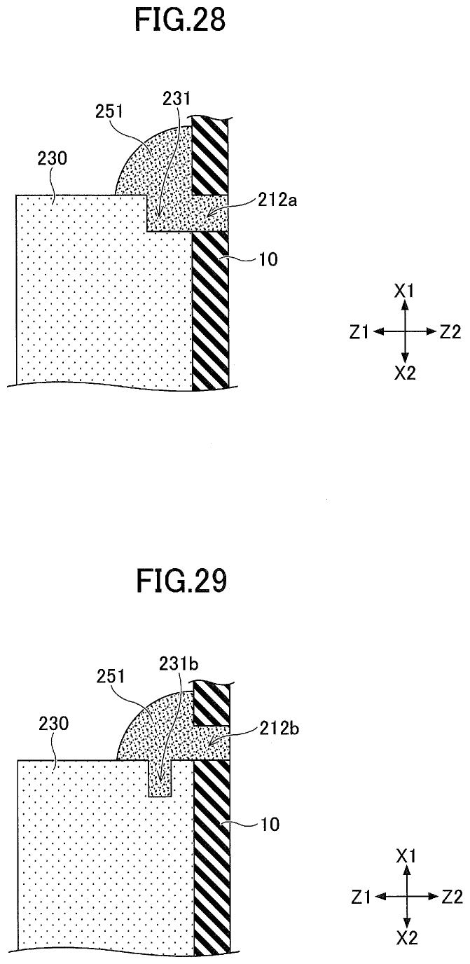

As illustrated in FIG. 28, through holes 212a as a variation of the recesses may be formed in the printed board 10 at positions corresponding to the first recesses 231, and an adhesive is applied to the first recesses 231 and the through holes 212a. Because the adhesive also enters the through holes 212a, the bonding area increases to improve the strength of the bonding of the printed board 10 and the lens member 230 by the first bonding part 251.

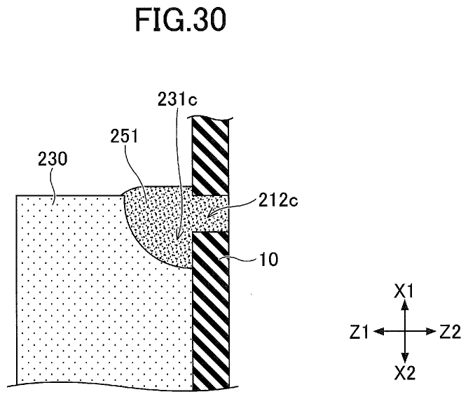

Likewise, as illustrated in FIG. 29, through holes 212b may be formed in the printed board 10 outside the lens member 230, and an adhesive is applied to the first recesses 231b and the through holes 212b. As illustrated in FIG. 30, through holes 212c may be formed in the printed board 10 at positions corresponding to the first recesses 231c, and an adhesive is applied to the first recesses 231c and the through holes 212c.

### Third Embodiment

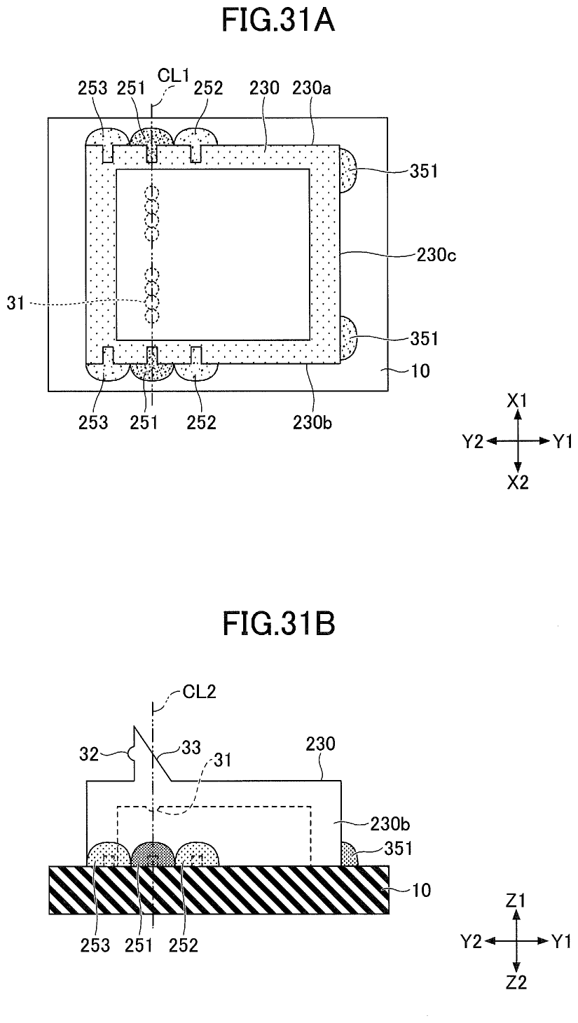

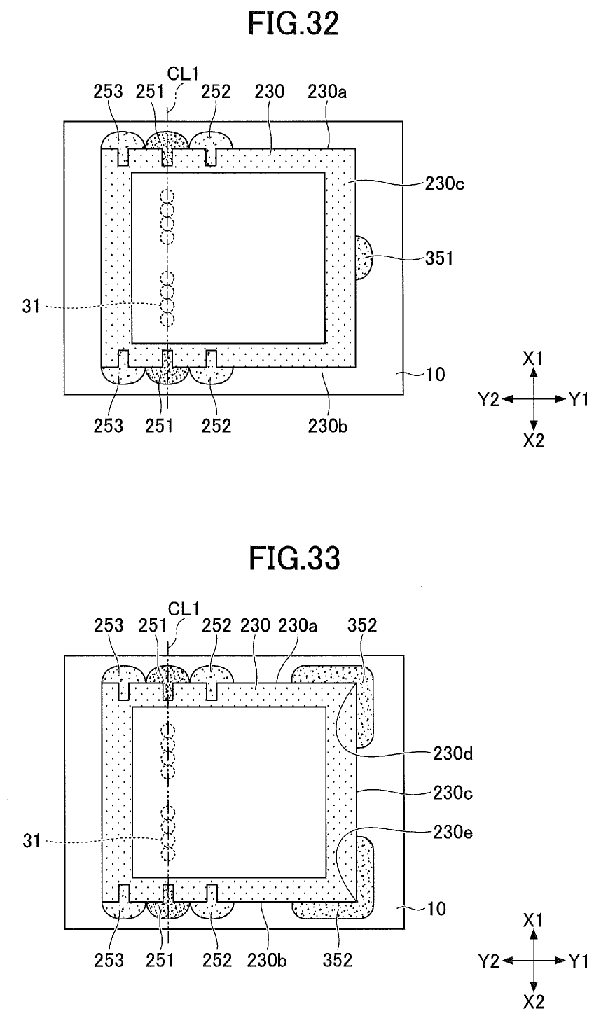

According to a third embodiment, the printed board 10 and the lens member 230 are further fixed by a fourth bonding part 351 as illustrated in FIGS. 31A and 31B after the process of FIGS. 16A and 16B. The third embodiment further improves the bonding strength of the printed board 10 and the lens member 230. An adhesive is applied on a surface 230c of the lens member 230 to form two fourth bonding parts 351. Alternatively, a single fourth bonding part 351 may be formed as illustrated in FIG. 32.

In FIG. 33, a fourth bonding part 352 is formed by applying an adhesive around a corner 230d and a corner 230e of the lens member 230.

In other respects than those described above, the third embodiment may be the same as the second embodiment.

According to the embodiments, at least one of the light emitter 21 and the light receiver 22 may be attached on the printed board 10.

Although one or more embodiments of the present invention have been described heretofore, the present invention is not limited to these embodiments, and variations and modifications may be made without departing from the scope of the present invention.

What is claimed is:

1. An optical module comprising:
a board on which at least one of a light emitter and a light receiver is provided;
a lens member including lenses which light from the light emitter enters or light enters the light receiver through; and
a first bonding part, a second bonding part, and a third bonding part each bonding the board and the lens member, the first bonding part positioned on a line passing through a center of each of the lenses, the second and third bonding parts being symmetrically positioned with respect to the line.

2. The optical module as claimed in claim 1, wherein
the lens member further includes a first recess formed in a side surface thereof on the line, and
the first bonding part is formed in the first recess.

3. The optical module as claimed in claim 2, wherein the lens member further includes a second recess and a third recess formed in the side surface on opposite sides of the first recess, and positioned symmetrically with respect to the line.

4. The optical module as claimed in claim 3, wherein the second bonding part and the third bonding part are in the second recess and the third recess, respectively.

5. The optical module as claimed in claim 3, wherein the board includes
a fourth recess at a position corresponding to the second recess; and
a fifth recess at a position corresponding to the third recess.

6. The optical module as claimed in claim 2, wherein the board includes a second recess at a position corresponding to the first recess.
